(19) United States
(12) Patent Application Publication
(10) Pub. No.: US 2026/0094589 A1
(43) Pub. Date: Apr. 2, 2026

(54) UNIVERSAL ADJUSTABLE MOUNTING SYSTEM FOR CURVED SURFACE ATTACHMENT

(71) Applicant: OFER WEBMAN, PHOENIX, AZ (US)

(72) Inventor: OFER WEBMAN, PHOENIX, AZ (US)

(21) Appl. No.: 19/342,625

(22) Filed: Sep. 28, 2025

Related U.S. Application Data
(60) Provisional application No. 63/700,641, filed on Sep. 28, 2024.

(51) Int. Cl. G10H 1/00; F16M 13/00

(52) U.S. Cl. CPC G10H 1/0091; F16M 13/005

(57) ABSTRACT

A universal adjustable mounting system for attaching rigid devices to curved surfaces includes a primary body with an integrated attachment mechanism and an adjustable corner element positioned at a strategic location. An actuator mechanism controls the position of the corner element to create angular compensation that enables the mounting system to conform to curved surfaces. The system accommodates flat, convex, concave, and irregular surface geometries using a single device, maintaining optimal contact and stability across the full adjustment range. Applications include musical instruments, automotive components, medical devices, industrial equipment, and consumer electronics. The invention eliminates the need for surface-specific mounting solutions while providing superior contact and stability compared to flexible mounting systems.

### CROSS-REFERENCE TO RELATED APPLICATIONS

This patent application claims the benefit of prior filed provisional patent application Ser. No. 63/700,641 which was filed on Sep. 28, 2024, which application is incorporated herein.

### BACKGROUND OF THE INVENTION

### 1. Field of the Invention

The present invention relates generally to mounting systems for attaching devices to curved surfaces, and more particularly to a universal adjustable mounting apparatus that enables rigid devices to conform to and securely attach to curved or irregular surfaces through an integrated angular adjustment mechanism.

### 2. Description of Related Art

Many applications require attaching rigid electronic devices, sensors, mechanical components, or other equipment to curved surfaces. Such applications span numerous industries including musical instruments, automotive systems, medical devices, consumer electronics, industrial equipment, aerospace components, and architectural installations.

Traditional mounting systems face critical limitations when attempting to attach flat or rigid devices to curved surfaces. Conventional flat-mount systems cannot properly contact curved surfaces, resulting in poor contact interface, reduced mechanical stability, inadequate vibration transfer, and compromised electrical connectivity. This fundamental incompatibility between rigid mounting devices and curved target surfaces creates significant challenges across multiple industries.

Existing solutions to this problem include custom brackets designed for specific surface geometries, flexible mounting systems that compromise stability and precision, complex multi-component adapter systems requiring careful component selection, and permanent modification of target surfaces. These approaches suffer from various drawbacks including high cost, limited compatibility, reduced performance, increased complexity, and the requirement for surface alteration.

Custom brackets require surface-specific design and manufacturing, making them impractical for applications involving multiple surface types or variable curvatures. Flexible mounts, while adaptable to some degree of curvature, compromise the stability and precision required for many applications. Multi-component systems introduce complexity, potential points of failure, and require users to select appropriate components for each specific application. Surface modification approaches require permanent alteration of target surfaces, which may not be permissible or desirable in many applications.

What is needed in the art is a universal mounting system that can accommodate various curved surface geometries using a single device, without requiring surface modification, while maintaining optimal contact and stability characteristics.

### SUMMARY OF THE INVENTION

The present invention provides a universal adjustable mounting system that solves the long-standing problem of attaching rigid devices to curved surfaces. The invention features an integrated adjustable corner mechanism that enables a rigid mounting device to conform to curved surfaces through controlled angular adjustment at a strategic pivot point.

In one embodiment, the invention comprises a mounting apparatus having a rigid primary body with an attachment mechanism, and an adjustable corner element positioned at a predetermined location on the primary body. An actuator mechanism is operatively connected to the adjustable corner element, wherein actuation of the actuator mechanism changes the position of the adjustable corner element to create angular compensation for surface curvature.

The invention enables a single mounting device to accommodate flat surfaces, convex curved surfaces, concave curved surfaces, and irregular surface geometries. The system maintains optimal surface contact across the entire range of adjustment, ensuring mechanical stability, vibration transfer, and secure attachment regardless of surface curvature.

Key advantages of the invention include universal compatibility with multiple surface types, optimal contact maximization for stability and function, enhanced transfer of vibration, heat, or signals, simplified installation through tool-free operation, and elimination of the need for multiple mounting solutions or surface modification.

The invention is applicable across numerous industries and use cases, including musical instruments (guitars, violins, drums), automotive applications (curved body panels, dashboards), medical devices (body-worn sensors), consumer electronics (curved displays, wearable devices), industrial applications (curved pipes, tanks, machinery), aerospace components, marine applications, architectural installations, and security systems.

### BRIEF DESCRIPTION OF THE DRAWINGS

The preferred embodiments of the present invention will hereinafter be described in conjunction with the appended drawings, wherein like designations denote like elements, and:

FIG. 1 is a perspective view of a universal adjustable mounting system in accordance with a preferred exemplary embodiment of the present invention;

FIG. 2 is a side view of a universal adjustable mounting system in accordance with a preferred exemplary embodiment of the present invention;

FIG. 3 is a side view of a universal adjustable mounting system in accordance with a preferred exemplary embodiment of the present invention;

FIG. 4 is a side view of a universal adjustable mounting system in accordance with a preferred exemplary embodiment of the present invention;

FIG. 5 is a side view of a universal adjustable mounting system in accordance with a preferred exemplary embodiment of the present invention; and

FIG. 6 is a method for deploying a universal adjustable mounting system in accordance with a preferred exemplary embodiment of the present invention.

### DETAILED DESCRIPTION OF THE PREFERRED EMBODIMENTS

In the most preferred embodiments of the present invention, a universal adjustable mounting system is incorporated into an electronic device and the universal adjustable mounting system is used to affix the electronic device to a curved surface. The curved surface may be a dash board, a windshield, a musical instrument, etc. The electronic device may be a speaker, a radar detector, dashcams, amplifiers, etc. In the most preferred embodiments of the present invention, the universal adjustable mounting system is incorporated or integrated into a system for sound augmentation of an acoustic musical instrument such as the systems shown in U.S. Pat. Nos. 9,111,517 and 9,424,824, which applications are incorporated herein by reference.

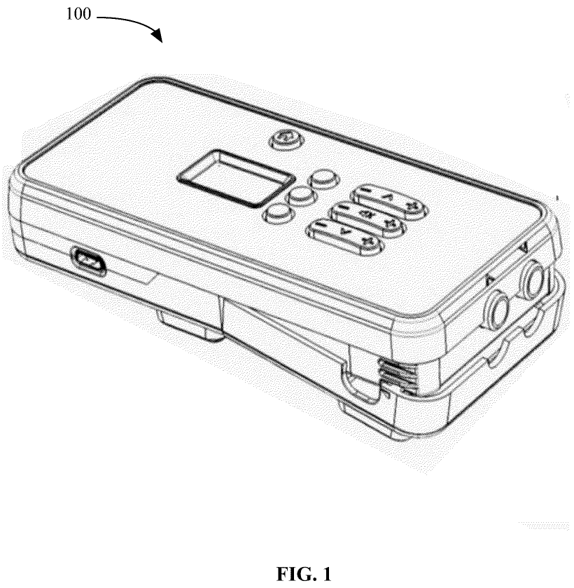

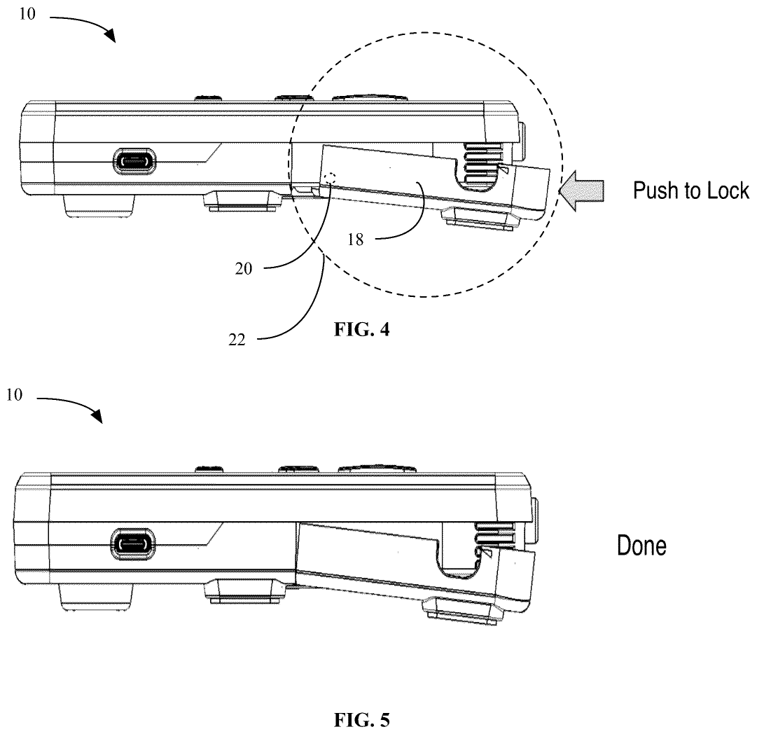

Referring now to the drawings, and particularly to FIGS. 1-5, there is shown a universal adjustable mounting system 10 according to the present invention, integrated with a system for sound augmentation of an acoustic musical instrument. The mounting system 10 comprises a rigid primary body 12 having one or more substantially flat mounting surfaces 14, an attachment mechanism 16 integrated with the primary body 12, and an adjustable corner element 18 positioned at a predetermined location on the primary body 12.

The primary body 12 forms the main structural element of the mounting system and provides a platform for integrating various attachment mechanisms and the device to be mounted. In the most preferred embodiments of the present invention, the primary body 12 has a generally rectangular configuration, although other geometric configurations are within the scope of the invention. The mounting surface 14 is configured to provide optimal contact with target surfaces and may incorporate surface texturing, padding, or other features to enhance grip and contact characteristics.

The attachment mechanism 16 may comprise magnetic elements, adhesive elements, mechanical fasteners, or combinations thereof. In embodiments utilizing magnetic attachment, the attachment mechanism 16 includes permanent magnets or electromagnets configured to engage with ferromagnetic target surfaces or with magnetic brackets attachable to non-ferromagnetic surfaces. Adhesive embodiments may utilize removable adhesives, permanent adhesives, or pressure-sensitive adhesive systems. Mechanical fastener embodiments may include screws, bolts, clips, or other mechanical attachment means.

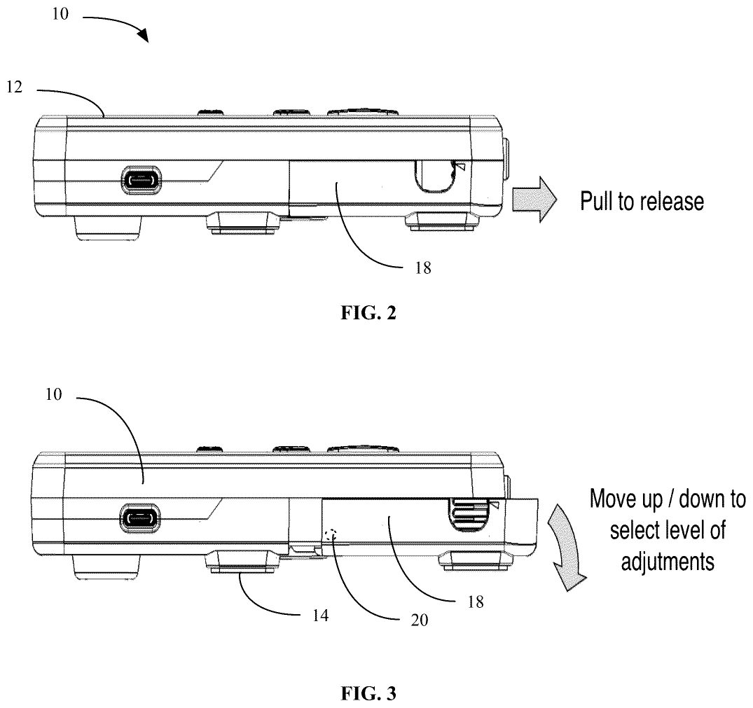

The adjustable corner element 18 represents a key innovation of the present invention. As shown in FIGS. 2-5, the adjustable corner element 18 is positioned at a strategic corner location of the primary body 12 and is configured to create angular compensation when actuated. In the most preferred embodiments, the adjustable corner element 18 comprises a combination of a sliding and a pivoting member that rotates about a hinge point and fixed axis 20, although alternative embodiments may utilize extendable members, sliding mechanisms, or other displacement mechanisms.

Referring particularly to FIGS. 2-4, an actuator mechanism 22 is operatively connected to the adjustable corner element 18. The actuator mechanism 22 enables user control of the corner element position and may comprise various actuation methods including push-pull actuators, rotary actuators, sliding actuators, or lever mechanisms. In the preferred embodiment shown, the actuator mechanism 22 comprises a push-pull actuator that requires no tools for operation and provides tactile feedback indicating proper adjustment.

The operation of the universal mounting system 10 is illustrated in FIGS. 2-5. When the system is configured for attachment to a flat surface, as shown in FIG. 2, the adjustable corner element 18 is positioned in a neutral position wherein the mounting surface 14 remains substantially planar. When adjustment is required for curved surface attachment, as shown in FIG. 2, the actuator mechanism 22 is operated to displace the adjustable corner element 18, creating an angular offset between the primary body 12 and the target curved surface.

The geometric relationships governing the adjustment mechanism are illustrated in

FIGS. 1-5. The angular displacement of the adjustable corner element 18 creates a corresponding angular compensation in the overall mounting surface orientation. This angular compensation enables the mounting surface 14 to conform to the curvature of the target surface, maintaining optimal contact across the entire mounting interface.

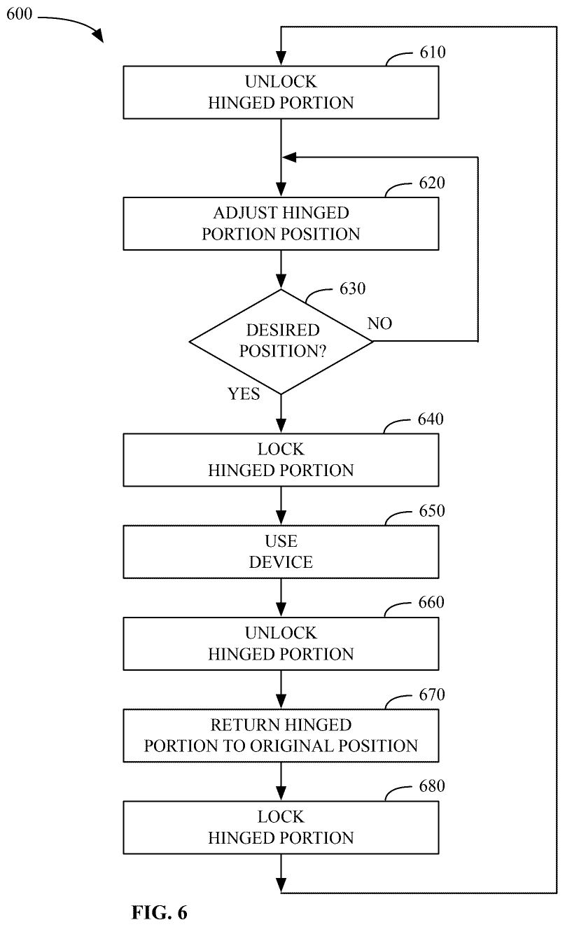

Referring now to FIG. 6, a method 600 for deploying a universal adjustable mounting system in accordance with a preferred exemplary embodiment of the present invention is depicted. As shown in FIG. 6, a hinged portion of the universal adjustable mounting system can be unlocked (STEP 610), thereby allowing the position of the hinged portion of the universal adjustable mounting system to adjusted relative to the main body of the universal adjustable mounting system (STEP 620).

Because the body portion and the hinged portion of the universal adjustable mounting system are connected by a hinge element, the position of the two portions can be adjusted to match the curvature of the curved surface to which the universal adjustable mounting system is to be attached until the desired position is achieved (STEP 630=“YES”). As shown in FIG. 6, if the correct relative positioning is not immediately achieved (STEP 630=“NO”) then the positioning can be repeatedly adjusted until the desired positioning is achieved.

Once the desired positioning has been achieved, the hinged portion can be locked into the desired position (STEP 640) and the device associated with the universal adjustable mounting system can be used for the desired purpose (STEP 650).

After use, the hinged portion can be unlocked (STEP 660) and returned to the original starting position (STEP 670) and locked into place (STEP 680) until ready to be used again. It should be noted that the position of the hinged portion does not negatively impact the operation of the integrated device and the integrated device may be successfully operated in any position.

The overall positioning of the device is accomplished by simply sliding the hinged portion in a direction parallel to the main horizontal portion of the device to unlock and release the hinged portion of the device from the main body of the device. Once released, the hinged portion can be dropped down into the desired position and locked into place by sliding the hinged portion towards the main body of the device. Once in the desired position, the longitudinal axis of the hinged portion will be at an angle relative to the longitudinal axis of the main body of the device, allowing the device to be connected to a curved surface.

Mounting system 10 may be attached to a curved musical instrument surface, such as the arched back of an acoustic guitar. The curvature of the instrument surface is accommodated by adjustment of the corner element 18, enabling secure attachment of electronic devices such as effects processors, pickups, or monitoring equipment. The universal nature of the mounting system eliminates the need for instrument-specific brackets while maintaining optimal contact and stability.

Mounting system 10 may be useful to an automotive application, wherein the system is attached to a curved dashboard surface. This application demonstrates the versatility of the invention across different industries and surface geometries. The same mounting system that accommodates musical instrument curvatures can be reconfigured for automotive surfaces without modification or additional components.

In alternative embodiments, the adjustable corner element 18 may comprise an extendable member that telescopes outward from the primary body 12. Such embodiments provide angular adjustment through linear displacement rather than rotational movement, while achieving the same functional result of surface curvature accommodation.

The actuator mechanism 22 may incorporate various user interface features to enhance operation. In preferred embodiments, the actuator provides tactile feedback indicating proper adjustment positions and may include visual indicators showing the degree of adjustment. Some embodiments may incorporate detents or positive positioning features that provide discrete adjustment positions corresponding to common curvature ranges.

For applications requiring accommodation of complex or irregular surface curvatures, embodiments may include multiple adjustable corner elements positioned at different locations on the primary body 12. Such multi-point adjustment systems enable conformance to surfaces having varying curvature in multiple directions.

Advanced embodiments of the invention may incorporate sensors for detecting surface curvature and automatically adjusting the corner element position. Such embodiments include control systems that process sensor feedback and actuate the adjustment mechanism to achieve optimal surface conformance without manual intervention.

The materials and manufacturing methods for the mounting system 10 may vary according to application requirements. The primary body 12 and adjustable corner element 18 may be manufactured from metals, polymers, composites, or combinations thereof. Manufacturing techniques may include injection molding, machining, additive manufacturing, or other appropriate methods. The selection of materials and manufacturing processes may be optimized for factors including strength, weight, cost, environmental resistance, and production volume requirements.

One skilled in the art will appreciate that many variations are possible within the scope of the claims. Thus, while the disclosure or certain preferred embodiments of the present invention are particularly shown and described above, it will be understood by those skilled in the art that these and other changes in form and details may be made therein without departing from the spirit and scope of the claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques.

Notwithstanding that the numerical ranges and values setting forth the broad scope of the disclosure are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the disclosed embodiments (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”), provided herein is intended merely to better illuminate the present disclosure and does not pose a limitation on the scope of the embodiments otherwise claimed. No language in the present specification should be construed as indicating any non-claimed element

1. A universal mounting apparatus for attaching devices to curved surfaces, comprising:
a rigid primary body having a substantially flat mounting surface;
an attachment mechanism integrated with the primary body;
an adjustable corner element positioned at a predetermined location on the primary body;
an actuator mechanism operatively connected to the adjustable corner element; and
wherein actuation of the actuator mechanism changes a position of the adjustable corner element to create angular compensation for surface curvature.

2. The apparatus of claim 1, wherein the adjustable corner element comprises a pivoting member that rotates about a fixed axis.

3. The apparatus of claim 1, wherein the adjustable corner element comprises an extendable member that telescopes outward from the primary body.

4. The apparatus of claim 1, wherein the actuator mechanism comprises a push-pull actuator requiring no tools for operation.

5. The apparatus of claim 1, wherein the actuator mechanism comprises a rotary actuator.

6. The apparatus of claim 1, wherein the adjustable corner element provides angular adjustment range of at least 15 degrees.

7. The apparatus of claim 1, wherein the attachment mechanism comprises at least one magnetic element.

8. The apparatus of claim 7, wherein the at least one magnetic element is configured to engage with a magnetic bracket attachable to the curved surface.

9. The apparatus of claim 1, wherein the attachment mechanism comprises at least one adhesive element.

10. The apparatus of claim 1, wherein the attachment mechanism comprises mechanical fasteners.

11. The apparatus of claim 1, configured to accommodate both convex and concave curved surfaces.

12. The apparatus of claim 1, wherein the curved surfaces include cylindrical surfaces, spherical surfaces, and irregular curved surfaces.

13. The apparatus of claim 1, further comprising electronic components housed within the primary body.

14. The apparatus of claim 13, wherein the electronic components comprise audio processing circuits.

15. The apparatus of claim 1, further comprising tactile feedback mechanism indicating proper adjustment of the corner element.

16. The apparatus of claim 1, wherein the mounting apparatus maintains consistent contact pressure across the mounting surface regardless of corner element position.

17. The apparatus of claim 1, specifically configured for attachment to acoustic guitar bodies having arched backs.

18. The apparatus of claim 17, further comprising audio effects processing circuitry and vibration transducers.

19. The apparatus of claim 1, configured for mounting electronic devices to curved automotive surfaces.

20. The apparatus of claim 19, wherein the electronic devices comprise navigation systems, cameras, or sensor arrays.

21. A method for mounting a rigid device to a curved surface, the method comprising the steps of:
providing a mounting device having a primary body with an attachment mechanism;
providing an adjustable corner element positioned at a corner of the primary body;
actuating the adjustable corner element to create an angular offset between the primary body and the curved surface;
positioning the mounting device against the curved surface such that the angular offset compensates for curvature of the surface; and
engaging the attachment mechanism to secure the mounting device to the curved surface.

22. The method of claim 21, wherein the curved surface is selected from the group consisting of: musical instrument bodies, automotive panels, architectural elements, and industrial equipment surfaces.

23. The method of claim 21, further comprising providing tactile feedback indicating proper adjustment of the corner element.

24. A mounting apparatus for universal curved surface attachment, the apparatus comprising:
a mounting device having a primary body and an adjustable corner mechanism;
an actuator for controlling angular position of the corner mechanism;
an attachment interface configured to engage with curved surfaces; and
wherein the corner mechanism creates angular compensation enabling optimal contact between the mounting device and surfaces having varying degrees of curvature.

25. The apparatus of claim 24, further comprising a second adjustable corner element positioned at a different corner of the primary body.

26. The apparatus of claim 25, wherein the first and second adjustable corner elements are independently actuatable.

27. The apparatus of claim 25, further comprising sensors for detecting surface curvature and automatically adjusting the corner element.

28. The apparatus of claim 27, further comprising a control system for automated corner adjustment based on sensor feedback.

29. The apparatus of claim 24, wherein the primary body and adjustable corner element are manufactured as an integrated unit.

30. The apparatus of claim 1, manufactured using injection molding techniques for mass production.
